(19) United States
(12) Patent Application Publication
(10) Pub. No.: US 2023/0085533 A1
(43) Pub. Date: Mar. 16, 2023

(54) METHOD FOR PROCESSING BORON NITRIDE NANOTUBE AND LIQUID CRYSTAL COMPOSITION AND BORON NITRIDE NANOTUBE FIBER THEREFROM

(71) Applicant: KOREA INSTITUTE OF SCIENCE AND TECHNOLOGY, Seoul (KR)

(72) Inventors: Se Gyu JANG, Wanju-Gun (KR); Hong Jin LIM, Wanju-Gun (KR); Seok Hoon AHN, Wanju-Gun (KR); Hun Su LEE, Wanju-Gun (KR); Yong Ho JOO, Wanju-Gun (KR); Sang Seok LEE, Wanju-Gun (KR); Hyun Jin CHO, Wanju-Gun (KR)

(73) Assignee: KOREA INSTITUTE OF SCIENCE AND TECHNOLOGY, Seoul (KR)

(21) Appl. No.: 17/553,193

(22) Filed: Dec. 16, 2021

(30) Foreign Application Priority Data
Aug. 30, 2021 (KR) 10-2021-0114555

(51) Int. Cl. C01B 21/064; C09K 19/06; C09K 19/54; D01F 8/18; D01D 5/06

(52) U.S. Cl. CPC C01B 21/064; C09K 19/061; C09K 19/542; D01F 8/18; D01D 5/06; C01P 2004/13; C01P 2004/64; C01P 2004/03; B82Y 40/00

(57) ABSTRACT

The present invention comprises the steps of contacting a boron nitride nanotube and a stabilizer in a solvent, and removing a portion of the solvent to obtain a liquid crystal composition including a liquid crystal in which at least a portion of the stabilizer is adsorbed on the surface of the boron nitride nanotube.

### CROSS-REFERENCE TO RELATED APPLICATIONS

Pursuant to 35 U.S.C. § 119 (a), this application claims the benefit of Korean Patent Application No. 10-2021-0114555, filed on Aug. 30, 2021, the contents of which are all hereby incorporated by reference herein in their entirety.

### BACKGROUND OF THE DISCLOSURE

### Field of the disclosure

The present disclosure relates to a method for processing a boron nitride nanotube and a liquid crystal composition and a boron nitride nanotube fiber therefrom.

### Related Art

Carbon nanotubes (CNTs) with excellent mechanical, thermal, and electrical properties have been extensively studied over the past 20 years and are being applied in various fields, but their use is limited when electrical insulation is required or when exposed to elevated temperature and oxidizing environments.

Recently, as an alternative to solve the above problems of carbon nanotubes, boron nitride nanotubes (BNNTs) are attracting attention. Boron nitride nanotubes (BNNTs) are structural analogs composed of boron atoms and nitrogen atoms instead of carbon atoms of carbon nanotubes (CNTs).

Boron nitride nanotubes have the same one-dimensional tube shape as carbon nanotubes, and have properties like carbon nanotubes, that is, low density, high mechanical strength, and high thermal conductivity, due to these structural features.

Since boron nitride nanotubes are composed of alternating bonds of boron and nitrogen atoms, it has insulation and piezoelectric properties due to a wide bandgap and high thermal neutron absorption capacity, and characteristically has higher chemical and oxidation resistance than carbon nanotubes due to stable bonding between nitrogen and boron, so it has the potential to be used in harsh environments such as space.

However, compared to studies on liquid crystal phase implementation for carbon-based nanomaterials and fiber or film formation using the same, boron nitride nanomaterials have a problem in that it is difficult to realize liquid crystal phase and wet fibers using the same.

This is because boron nitride nanomaterials have difficulty in surface modification due to their excellent oxidation resistance and chemical resistance, which makes it difficult to secure dispersion stability in solution, and there is a limit to the application of the dispersion method applied to carbon materials such as CNT, and thus improvement is required.

### SUMMARY

The present disclosure provides a method for processing a boron nitride nanotube and a liquid crystal composition and a boron nitride nanotube fiber therefrom.

An exemplary embodiment of the present disclosure provides a method for processing a boron nitride nanotube, the method may include: contacting the stabilizer with boron nitride nanotubes in a solvent; and obtaining a liquid crystal composition including a liquid crystal in a state in which at least a part of the stabilizer is adsorbed on the surface of the boron nitride nanotubes by removing a portion of the solvent.

The stabilizer may be adsorbed to the surface of the boron nitride nanotubes through the secondary interactions, disperse the boron nitride nanotubes through the repulsive force between the boron nitride nanotubes, and include at least one of monomers, oligomers, polymers, and copolymers including at least one Lewis base capable of providing an electron pair to form a secondary bond.

The stabilizer may include monomers, oligomers, polymers, or copolymers thereof selected from the group consisting of Vinylpyrrolidone, Vinylalcohol, Acrylonitrile, Dopamine, and combinations thereof.

The stabilizer may be selected from the group consisting of a Vinylpyrrolidone-vinylimidazole c opolymer of [Formula 1] below, a Vinylpyrrolidone-vinylimidazolium copolymer of [Formula 2], and combinations thereof

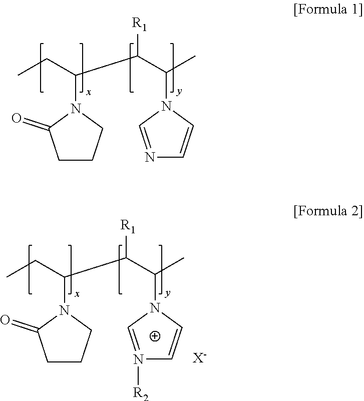

In the above formula, R1 and R2 may be the same or different, may represent hydrogen or a hydrocarbon group having 1 to 16 carbon atoms, respectively, and may optionally include one or more heteroatoms selected from oxygen, sulfur, nitrogen, phosphorus, fluorine, chlorine, bromine, iodine, and silicon. X− in Chemical Room 2 may be an anion of an imidazolium-based ionic liquid and may use a halogen anion component including Cl⁻ and Br⁻. In Formulas 1 and 2, x may be 1 to 128, and y may be 0 to 1.

The solvent may include at least one of water, alcohol, dimethylformamide, dichloromethane, acetone, and amines, the contacting may be performed by supplying external energy to a mixed solution in which the solvent, the boron nitride nanotubes, and the stabilizer are mixed, and the weight ratio of the boron nitride nanotubes and the stabilizer in the mixed solution may be 1:0.01 to 1:10.

The liquid crystal may be lyotropic nematic phase and include 100 parts by weight of the boron nitride nanotube and 30 parts by weight to 300 parts by weight of the stabilizer.

The method may further include extruding the liquid crystal composition by contacting the liquid crystal composition with a coagulant; gelling the extruded liquid crystal composition; and obtaining a gel fiber composite by stretching and fiberizing the gelled liquid crystal composition.

The method may further include obtaining boron nitride nanotube fibers by densifying the gel fiber composite; wherein the densifying may include obtaining a first boron nitride nanotube fiber through a first densifying to further remove the solvent in the gel fiber composite; and obtaining a second boron nitride nanotube fiber through a second densifying to remove the stabilizer of the first boron nitride nanotube fiber.

The impurity of the boron nitride nanotube may be 1% by area to 30% by area.

An exemplary embodiment of the present disclosure provides a liquid crystal composition including a liquid crystal of boron nitride nanotubes, the liquid crystal composition may include: boron nitride nanotubes, a stabilizer, and a solvent, wherein at least a portion of the stabilizer is adsorbed on the surface of the boron nitride nanotubes, and the boron nitride nanotubes may be in a liquid crystal state aligned in a predetermined direction in the solvent.

The liquid crystal may include: 100 parts by weight of the boron nitride nanotube and 30 parts by weight to 300 parts by weight of the stabilizer, 20% to 80% by weight of the stabilizer may be adsorbed to the boron nitride nanotube and the remaining stabilizer may be contained in the solvent, and the solvent may include at least one of water, alcohol, diol, dimethylformamide, dichloromethane, acetone, and amines, wherein the concentration of the boron nitride nanotubes in the liquid crystal composition is 0.05 wt % to 30 wt %.

The liquid crystal may include: a first concentration section showing an isotropic state in which the viscosity increases as the concentration of the boron nitride nanotube increases in the solvent; a second concentration section having a higher concentration than the first concentration section and decreasing the viscosity than the first concentration section to indicate a biphase state; and a third concentration section having a higher concentration than the second concentration section and increasing the viscosity than the second concentration section to indicate a lyotropic nematic phase state.

The liquid crystal may be divided into a total of three regions with a viscosity according to the shear rate in the lyotropic nematic phase, and the liquid crystal may include: a first region exhibiting shear thinning at a low shear rate, and in which the formed liquid crystal domains may move in translation and the liquid crystal domains may grow; a second region having a constant viscosity section at an intermediate shear rate, and in which the alignment of the liquid crystal domains in the translation and shear directions competitively may occur; and a third region exhibiting shear thinning again at a high shear rate, and in which the liquid crystal domains may be predominantly aligned in the shear direction.

An exemplary embodiment of the present disclosure provides a boron nitride nanotube fiber may include a boron nitride nanotube, wherein a boron nitride nanotube fiber has optical birefringence, and at least a portion of the boron nitride nanotube may be arranged in a predetermined direction.

The boron nitride nanotube fibers may include boron nitride nanotubes and a stabilizer, at least a portion of the stabilizer may be adsorbed on the surface of the boron nitride nanotube, and a degree of alignment may be 0.5 I_{VV}/I_{VH} to 5.5 I_{VV}/I_{VH}.

The boron nitride nanotube fibers may include 20 parts by weight to 60 parts by weight of the stabilizer based on 100 parts by weight of the boron nitride nanotube, and the boron nitride nanotube fiber may have a tensile strength of 1 cN/tex to 8 cN/tex, an elongation at break of 1% to 5%, and a modulus of 200 cN/tex to 600 cN/tex.

The stabilizer may be adsorbed to the surface of the boron nitride nanotubes through the secondary interactions, the stabilizer may help to disperse the boron nitride nanotubes through a repulsive force between the boron nitride nanotubes, and the stabilizer may include at least one of monomers, oligomers, polymers, and copolymers comprising at least one Lewis base capable of providing an electron pair to form a secondary bond.

The boron nitride nanotube fiber may have at least a portion of the boron nitride nanotube in the boron nitride nanotube fiber aligned in the axial direction of the fiber, and the boron nitride nanotube fiber may have a degree of alignment of 1.5 I_{VV}/I_{VH} 6.5 I_{VV}/I_{VH}.

The boron nitride nanotube fiber may have a tensile strength of 1 cN/tex to 8 cN/tex, an elongation at break of 0.1% to 5%, and a modulus of 1000 cN/tex to 2000 cN/tex.

The boron nitride nanotube fiber may have a tensile strength of 1.5 cN/tex to 8 cN/tex, an elongation at break of 0.3% to 3%, and a modulus of 1200 cN/tex to 2000 cN/tex.

### BRIEF DESCRIPTION OF THE DRAWINGS

FIG. 1 shows a method for processing a boron nitride nanotube and a liquid crystal composition and a boron nitride nanotube fiber therefrom according to an embodiment of the present invention,

FIG. 2 shows a stabilizer synthesis method according to an embodiment of the present invention,

FIG. 3 is related to liquid crystal evaluation 1 according to an experimental example of the present invention, showing whether a boron nitride nanotube liquid crystal is implemented according to the type of stabilizer,

FIG. 4 is related to liquid crystal evaluation 2 according to an experimental example of the present invention, showing the dispersion stability and de-bundling efficiency of the boron nitride nanotube liquid crystal according to the type of stabilizer,

FIG. 5 and FIG. 6 relate to liquid crystal evaluation 3 according to an experimental example of the present invention, showing the polarizer image and viscosity according to the boron nitride nanotube liquid crystal concentration according to the type of stabilizer and the viscosity according to the shear rate of the lyotropic nematic liquid crystal,

FIG. 7 and FIG. 8 relate to the fiber evaluation 2 according to the experimental example of the present invention, showing the result of checking the amount of stabilizer in the boron nitride nanotube fiber by TGA and the cross-sectional SEM image of the boron nitride nanotube fiber before and after heat treatment, and

FIG. 9 relates to fiber evaluation 3 according to an experimental example of the present invention, showing whether the boron nitride nanotube fibers have birefringence and alignment.

### DESCRIPTION OF EXEMPLARY EMBODIMENTS

The present inventive concept described below can apply various transformations and can have various embodiments, and specific embodiments are illustrated in the drawings and described in detail. However, this is not intended to limit the present inventive concept to a specific embodiment, and should be understood to include all transformations, equivalents, or substitutes included in the technical scope of the present inventive concept.

The above objects, other objects, features, and advantages of the present invention will be easily understood through the following preferred embodiments in conjunction with the accompanying drawings. However, the present invention is not limited to the embodiments described herein and may be embodied in other forms. Rather, the embodiments introduced herein are provided so that the disclosed content may be thorough and complete, and the spirit of the present invention may be sufficiently conveyed to those skilled in the art.

Hereinafter, terms such as “comprise” or “have” are intended to designate that a feature, number, step, operation, component, part, or combination thereof described in the specification exists, and includes one or more other features, or it is to be understood that the existence or addition of numbers, steps, operations, components, parts, or combinations thereof is not precluded in advance.

Unless otherwise specified, all numbers, values, and/or expressions expressing quantities of ingredients, reaction conditions, polymer compositions, and formulations used herein contain, among other things, numbers that essentially occur in obtaining such values.

Since they are approximations reflecting various uncertainties in the measurement, it should be understood as being modified by the term “about” in all cases.

Also, where numerical ranges are disclosed in this description, such ranges are continuous and inclusive of all values from the minimum to the maximum of the range, unless otherwise indicated.

Throughout the specification, when a part, such as a layer, film, region, plate, etc., is referred to as “on” or “above” another part, it includes not only the case where it is directly on the other part, but also the case where another part is in between. Throughout the specification, terms such as first, second, etc. may be used to describe various components, but the components should not be limited by the terms. The terms are used only for the purpose of distinguishing one component from another.

Throughout the specification, terms such as first, second, etc. may be used to describe various components, but the components should not be limited by the terms. The terms are used only for the purpose of distinguishing one component from another.

Although the terms first, second, etc. may be used to describe various elements, components, regions, layers, and/or regions, it will be understood that such elements, components, regions, layers, and/or regions should not be limited by these terms.

In addition, the processes described in the present invention do not necessarily mean that they are applied in order. For example, where a first step and a second step are described, it will be understood that the first step does not necessarily have to be performed before the second step.

Hereinafter, a method of manufacturing boron nitride nanotube fibers using a boron nitride nanotube liquid crystal according to an embodiment will be described in detail with reference to the drawings.

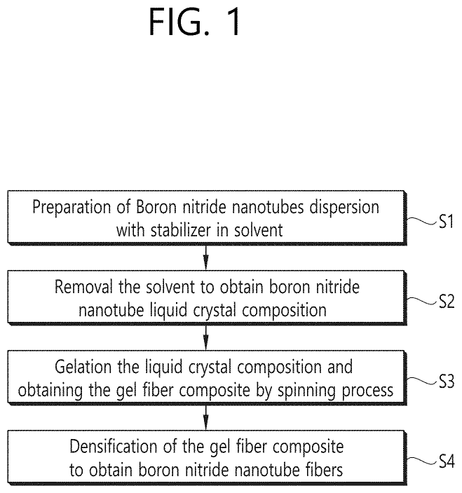

FIG. 1 shows a method for processing a boron nitride nanotube and a liquid crystal composition and a boron nitride nanotube fiber therefrom according to an embodiment of the present invention.

First, a boron nitride nanotube and a stabilizer are brought into contact in a solvent (S1).

The boron nitride nanotubes may have an impurity of 15% by area or less, 20% by area or less, 25% by area or less, or 30% by area or less, and more specifically, 1% by area to 30% by area, 5% by area to 30% by area, 10% by area to 30% by area, or 10% by area to 25% by area.

The boron nitride nanotube has a one-dimensional tube structure in which each of boron and nitrogen atoms having a hexagonal structure cross each other and form sp2 covalent bonds with adjacent atoms.

In particular, although boron and nitrogen atoms are basically formed as basic repeating units, they may also be formed in a polygonal structure in the manufacturing step.

In addition, when forming a layered form in a three-dimensional structure, it may be composed of a plurality of layers, and terminal atoms of boron and nitrogen atoms may exist in the form of covalent bonds as hydrogen atoms.

Specific forms of the boron nitride nanotubes may be, for example, at least one selected from the group consisting of single-walled, double-walled, multi-walled, bundle-type, rope-type, bamboo-type boron nitride nanotubes, and combinations thereof

The stabilizer may include at least one of monomers, oligomers, polymers, and copolymers including at least one Lewis base capable of providing an electron pair to form a secondary bond.

The stabilizer may include monomers, oligomers, polymers, and copolymers thereof selected from the group consisting of Vinylpyrrolidone, Vinylalcohol, Acrylonitrile, Dopamine, and combinations thereof; however the present invention is not limited thereto.

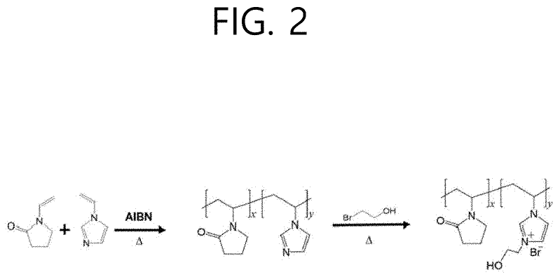

FIG. 2 shows a stabilizer synthesis method according to an embodiment of the present invention.

The vinyl pyrrolidone of the copolymer is bonded to the boron nitride nanotube through a lone pair of electrons, and the vinyl imidazolium gives an electrostatic interaction force, so even if the distance between the tubes is sufficiently close, the van der Waals force is able to be overcome.

The boron nitride nanotubes are agglomerated by hydrophobicity and van der Waals forces, and as the stabilizer is bound or adsorbed to the boron nitride nanotubes, the boron nitride nanotubes are peeled off or separated at the level of a single nanomaterial. As a result, it is possible to improve the dispersibility at a high concentration without surface modification of the boron nitride nanotubes.

Specifically, the stabilizer may be selected from the group consisting of a vinylpyrrolidone-vinylimidazole copolymer of [Formula 1] below, a vinylpyrrolidone-vinylimidazolium copolymer of [Formula 2], and combinations thereof.

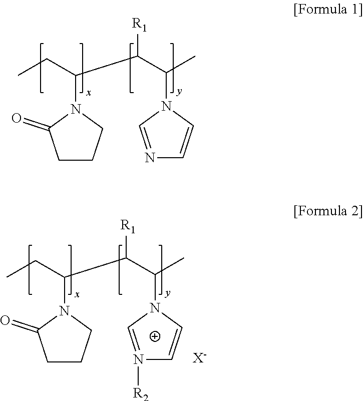

In the above formula, R1 and R2 are the same or different, represent hydrogen or a hydrocarbon group having 1 to 16 carbon atoms, respectively, and may optionally be included at least one hetero atom selected from oxygen, sulfur, nitrogen, phosphorus, fluorine, chlorine, bromine, iodine, and silicon. X⁻ in Chemical Room 2 is an anion of an imidazolium-based ionic liquid, and a halogen anion component including Cl⁻ and Br⁻ may be used. In Formulas 1 and 2, x may be 1 to 128, 10 to 50, or 20 to 40, and y may be 0 to 1.

The solvent may include at least one of water, alcohol, dimethylformamide, dichloromethane, acetone, and amines.

The contact of the boron nitride nanomaterial and the stabilizer in the solvent may be performed in a state in which external energy is supplied to a mixed solution in which the solvent, the boron nitride nanotube and the stabilizer are mixed.

In the mixed solution, the weight ratio of the boron nitride nanotubes to the stabilizer may be 1:0.01 to 1:10.

External energy supply may be performed using at least one of magnetic stirring, physical stirring, ultrasonic waves, mixer, high-pressure injection, a ball mill, three roll mills, and a kneader, but is not limited thereto.

When the boron nitride nanotube and the stabilizer are brought into contact in a solvent and external energy is supplied, at least a portion of the stabilizer is adsorbed to the surface of the boron nitride nanotube.

Next, a part of the solvent is removed to obtain a liquid crystal composition including a liquid crystal in which at least a part of the stabilizer is adsorbed on the surface of the boron nitride nanotube. (S2)

The liquid crystal composition contains boron nitride nanotube liquid crystal, and the boron nitride nanotube liquid crystal contains boron nitride nanotube and a stabilizer.

Removal of the solvent may be performed using at least one of rotary concentration evaporation, evaporation through micro heat, and filtration through a filter, but is not limited thereto.

In this process, 10% to 90% of the solvent in the mixed solution may be removed.

The liquid crystal composition includes boron nitride nanotubes, a stabilizer, and a solvent.

The stabilizer is adsorbed on the surface of the boron nitride nanotubes, and the liquid crystal state is formed in which the boron nitride nanotubes are aligned in a certain direction in the solvent.

The liquid crystal may include 100 parts by weight of boron nitride nanotubes and 30 to 300 parts by weight of the stabilizer.

In the present invention, the boron nitride nanotube liquid crystal may have a lyotropic nematic phase.

The concentration of boron nitride nanotubes in the liquid crystal composition may be 0.05 wt % to 30 wt %.

In the present invention, the stabilizer is adsorbed to the surface of the boron nitride nanotubes through a the secondary interactions, and the boron nitride nanotubes are dispersed through a repulsion force between the boron nitride nanotubes.

The repulsion force between the boron nitride nanotubes may include an electric repulsion force (electrostatic and electrosteric forces) and steric hindrance.

The stabilizer is adsorbed on the surface of the boron nitride nanotube either spontaneously or by receiving external energy through a secondary bond, so that when the concentration of the boron nitride nanotube is increased, it inhibits re-agglomeration or agglomeration by using the electrostatic interaction force and the repulsive force between the boron nitride nanotubes.

20% to 80% by weight of the stabilizer is adsorbed to the boron nitride nanotube, and the remaining stabilizer may be included in the solvent.

In the liquid crystal obtained through step S2, the concentration indicating the liquid crystal state varies depending on the impurities content, aspect ratio, and surface defects of the boron nitride nanotube, and the viscosity of the liquid crystal varies according to the concentration and phase change.

Viscosity can be problematic in terms of processability but is a useful feature in other respects. For example, when the boron nitride nanotube liquid crystal is solidified by a coagulant, a tensile force may be applied, and the liquid crystal may be stretched.

The stabilizer in the present invention is physically combined with a single level of boron nitride nanotubes to impart to the boron nitride natotubes an electrostatic interaction forces including electrostatic and electrosteric forces and steric hindrance, and repulsion forces between tubes.

The liquid crystal may have a first concentration section showing an isotropic state in which the viscosity increases as the concentration of boron nitride nanotubes increases in the solvent, and a second concentration having a higher concentration than the first concentration section and decreasing the viscosity than the first concentration section to indicate a dual phase, and a third concentration section having a higher concentration than the second concentration section, an increase in viscosity than the second concentration section, and representing a lyotropic nematic phase state.

In addition, the lyotropic liquid crystal phase of the anisotropic material may have characteristics of a lyotropic nematic liquid crystal, which shows a first region showing a shear thinning phenomenon at a low shear rate due to growth and motion of a liquid crystal domains according to the shear rate, and showing translational motion of the liquid crystal domains and growth of the liquid crystal domain, a second region showing a constant viscosity section at and intermediate shear rate, in which the translational motion of the liquid crystal domain and the alignment of the liquid crystal domains in the shear direction competitively occur, and a third region showing a shear thinning phenomenon again at a high shear rate and the liquid crystal domains are pre dominantly aligned in the shear direction.

As the concentration increases, the rod-rod interaction begins to occur at a given concentration due to competition between the electrostatic interaction force and the van der Waals attraction, resulting in a liquid-crystal state exhibiting practically liquid-crystal behavior.

The solvent may be removed so that the concentration of the boron nitride nanotubes is increased to become a liquid crystal solution in an isotropic solution, and also causes a change in viscosity to exhibit liquid crystal behavior.

On the other hand, when the boron nitride nanotube liquid crystal composition is prepared using a stabilizer to which an electrostatic interaction force is not imparted, the van der Waals attraction between the nanotubes cannot be sufficiently overcome, and the phase transition concentration to the liquid crystal is increased.

In addition, the unpurified boron nitride nanotubes contain a large number of isotropic impurities, which interferes with the self-assembly between the rods and rods at high concentrations, so that the liquid crystal phase cannot be formed, and aggregation occurs, thereby making it impossible to obtain a liquid crystal composition.

In general, the viscosity tends to increase as the concentration of the liquid crystal composition increases, materials exhibiting lyotropic liquid crystal properties, such as boron nitride nanotubes, can more easily slide with each other when liquid crystal domains are formed, and rod-rod interactions occur. Although the concentration of the liquid crystal composition gradually increases, the characteristic that the viscosity gradually decreases at the concentration at which the phase change occurs can be seen in the behavior of the liquid crystal polymer having an anisotropic structure.

Next, after extrusion of the liquid crystal composition, through gelation and elongation, an arrangement is induced, and a gel fiber composite in which the boron nitride nanotubes are oriented in a certain direction is obtained. (S3)

The step of obtaining the gel fiber composite comprises the steps of extruding the liquid crystal composition by contacting the liquid crystal composition and a coagulant; gelling the extruded liquid crystal composition; and stretching and fiberizing the gelled liquid crystal composition to obtain a gel fiber composite.

The alignment of the liquid crystal can be easily controlled through the flow field (shear flow) and extensional flow, which are external fields in the liquid crystal solution.

The content of boron nitride nanotubes oriented in a certain direction in the gel fiber composite may be 50% or more, 60% or more, 90% or more, 99% or more, and may be 50 to 80%, 50 to 99.99%.

% in the present invention represents weight percent unless otherwise specified.

The coagulants may include at least one selected from acetone, sodium hydroxide (NaOH), potassium hydroxide (KOH), ethyl acetate (ethyl acetate), butyl acetate (Butyl acetate), polyvinyl alcohol (PVA), polymethacrylate (PMMA), polyethyleneimine (PEI), polyethylene oxide (PEO), and borax.

Fiberization through extrusion and elongation can be performed through wet spinning and electrospinning using an orifice.

The orifice may be used at least one or more from the group consisting of a needle, a glass capillary tube, and a film die. The tensile ratio may be 1.05 to 1.5.

Next, a boron nitride nanotube fiber is obtained by densifying the gel fiber composite. (S4)

Densification includes the steps of obtaining a first boron nitride nanotube fiber (boron nitride nanotube fiber containing a stabilizer) through a first densification to further remove a solvent in the gel fiber composite; and obtaining a second boron nitride nanotube fiber through a second densification of removing the stabilizer of the first boron nitride nanotube fiber.

The first densification is to remove the solvent from the gel fiber composite and it can be naturally dried at a temperature of 20° C. to 180° C. under conditions of 15 h to 36h.

Preferably, through slow evaporation, the alignment and density of the nanotubes are increased, and the mechanical properties can be improved because there is no wrinkle, and the surface is smooth.

The second densification removes the stabilizer remaining in the first densified fiber, which may be achieved through heat treatment.

Through the second densification, more than 90%, more than 99%, or more than 99.9% of the stabilizer can be removed.

Specifically, the second densification may be performed at a temperature of 200° C. to 1000° C. under conditions of 0.5 h to 10 h.

The boron nitride nanotube fibers obtained through the first densification include boron nitride nanotubes and a stabilizer, a stabilizer may be adsorbed on the surface of the boron nitride nanotubes, and at least some of the boron nitride nanotubes may be arranged in a predetermined direction.

The content of boron nitride nanotube oriented in a certain direction in the boron nitride nanotube fiber containing the stabilizer obtained through the first densification may be 50% or more, 60% or more, 90% or more, 99% or more, 50 to 80%, 50 to 99.99%.

In the boron nitride nanotube fiber including the stabilizer obtained through the first densification, the stabilizer may be 20 to 60 parts by weight based on 100 parts by weight of the boron nitride nanotube.

The first boron nitride nanotube fibers including the stabilizer obtained through the first densification have a tensile strength of 1 cN/tex to 8 cN/tex, an elongation at break of 1% to 5%, and a modulus of 200 cN/tex to 600 cN/tex, and a degree of alignment may be 0.5 I_{VV}/I_{VH} to 5.5 I_{VV}/I_{VH}.

The boron nitride nanotube fiber including the stabilizer obtained through the first densification may have optical birefringence.

In the second boron nitride nanotube fiber that does not contain a stabilizer obtained through the second densification, at least a portion of the boron nitride nanotube in the boron nitride nanotube fiber is aligned in the axial direction of the fiber.

The second boron nitride nanotube fibers not containing the stabilizer obtained through the second densification have a tensile strength of 1 cN/tex to 8 cN/tex or 1.5 cN/tex to 8 cN/tex, an elongation at break of 0.1% to 5% or 0.3% to 3%, a modulus of 1000 cN/tex to 2000 cN/tex or 1200 cN/tex to 2000 cN/tex, and an alignment degree of 1.5 I_{VV}/I_{VH} to 6.5 I_{VV}/I_{VH}.

The boron nitride nanotube fiber obtained in the present invention can be used as a functional composite material to be usefully applied not only as a structural composite material, but also in the field of next-generation new technologies such as wearable devices, electric, electronic, and biofields, and new space materials such as radiation shielding.

Exemplary evaluation examples are described in more detail through the following experimental examples. However, the experimental examples are for illustrative purposes only, and the scope of the present invention is not limited thereto.

### Stabilizer Experiment

### Stabilizer Example 1—Stabilizer Synthesis

The stabilizer contains vinyl pyrrolidone, which can physically bond to the surface of boron nitride nanotubes, and vinyl imidazole, which can impart electrostatic repulsion through quaternization, in a molar ratio of 1:1 to 48:1 and is added to ethanol as a solvent together with azobisisobutyronitrile as an initiator to synthesize a polymer in a nitrogen atmosphere at 75° C. for 17 hours.

It was used after purification through precipitation in butyl acetate from the synthesized polymer solution. In order to impart additional electrostatic attraction to the synthesized polymer, a quaternization reaction was performed with bromoethanol and ethanol as a solvent at 75° C. for 24 hours.

The polymer subjected to the quaternization reaction was purified by precipitation in butyl acetate, and then dried in a vacuum oven for one day before use.

In a 125 g batch size, the concentration of active material in polymer synthesis was 20 wt %; azobisisobutyronitrile at 0.37 g; Bromoethanol for the quaternization reaction was synthesized by adding 140% or more of the VI mole of the copolymer to obtain a functionalized polymer stabilizer having a weight average molecular weight of 40,000 in a yield of 92%.

The polymer stabilizer used in the following experiments had a x:y ratio of 32:1 in Formula 1.

### Boron Nitride Nanotube Liquid Crystal Experiment

### Liquid Crystal Example 1—Preparation of Boron Nitride Nanotube Liquid Crystal

A mixed solution was prepared by adding the boron nitride nanotube content to 1 mg/ml, and the synthesized stabilizer and boron nitride nanotube in a weight ratio of 1:1 to the aqueous solution.

The boron nitride nanotubes were sintered at 650° C. in an air atmosphere for 6 hours, and the sintered boron nitride nanotubes were repeatedly washed in water to remove oxidized boron species and two-dimensional boron nitride plates to obtain the lower layer solution. A purified boron nitride nanotube was obtained. The impurity of the purified boron nitride nanotube was about 22 parts by area, which was obtained through SEM image analysis.

Ultrasound was applied for 2 hours to peel the boron nitride nanotubes in the mixed solution at a single level.

Thereafter, a portion of the solvent was removed to control the concentration of boron nitride nanotubes.

### Liquid Crystal Example 2—Preparation of Boron Nitride Nanotube Liquid Crystal

It was carried out by the method of Liquid Crystal Example 1, except that polyvinylpyrrolidone (55 k) was used as the stabilizer, and an aqueous solution was used as the solvent.

### Liquid Crystal Comparative Example 1—Preparation of Boron Nitride Nanotube Liquid Crystal

It was carried out by the method of Liquid Crystal Example 1, except that polyvinylpyridine (160 k) was used as the stabilizer, and ethanol was used as the solvent.

### Liquid Crystal Comparative Example 2—Preparation of Boron Nitride Nanotube Liquid Crystal

Although carried out by the method of Liquid Crystal Example 1, a stabilizer prepared by synthesizing boron nitride nanotubes containing impurities of about 52 area part % or more that were not purified was used, and an aqueous solution was used as the solvent.

### Liquid Crystal Evaluation 1—the Formation of Boron Nitride Nanotube Liquid Crystal According to the Type of Stabilizer

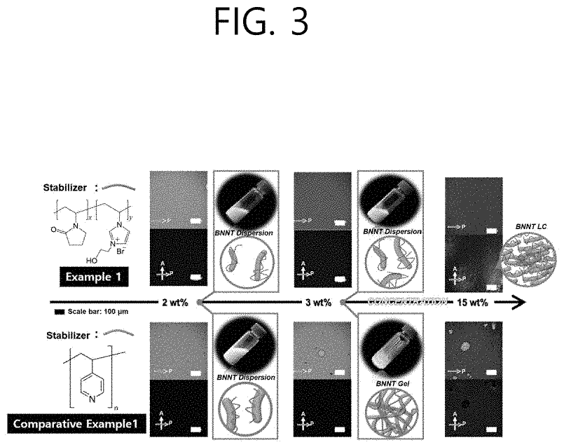

FIG. 3 shows whether a boron nitride nanotube liquid crystal is implemented according to the type of stabilizer.

The state change of the solution formed according to the type of stabilizer prepared in Liquid Crystal Example 1 and Liquid Crystal Comparative Example 1 through optical microscopy and polarized optical microscopy equipment and whether a boron nitride nanotube liquid crystal is implemented are shown in FIG. 3.

As can be confirmed from FIG. 3, as the concentration of the boron nitride nanotube dispersion prepared in Liquid Crystal Example 1 increased, it existed in a “liquid state”, and birefringence was confirmed on the boron nitride nanotube liquid crystal.

On the other hand, as the concentration of the boron nitride nanotube dispersion prepared in Liquid Crystal Comparative Example 1 increased, it was “gelled” instead of “liquid state”, and birefringence could not be confirmed in the liquid crystal phase of the boron nitride nanotube liquid crystal.

### Liquid Crystal Evaluation 2—Confirmation of Boron Nitride Nanotube Dispersing Quality

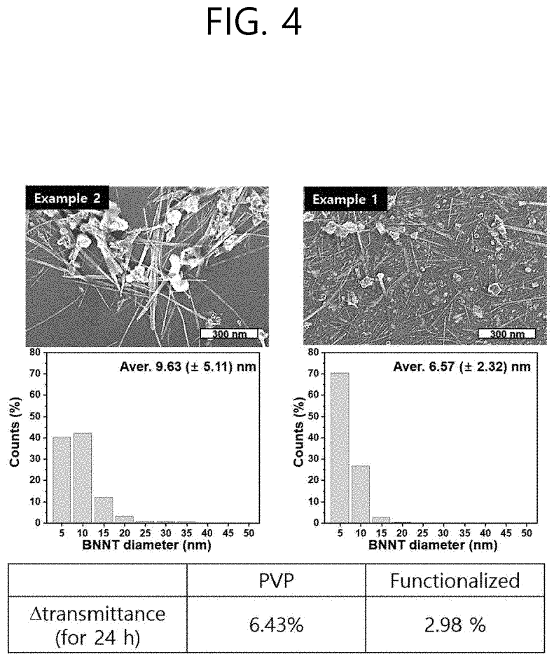

The boron nitride nanotube dispersions of Liquid Crystal Examples 1 and 2 were diluted to 0.4 mg/ml through Turbiscan equipment, and the results of long-term dispersion stability data are shown in FIG. 4 based on this.

FIG. 4 shows dispersion stability and de-bundling efficiency of the boron nitride nanotube liquid crystal according to the type of stabilizer.

As can be seen in FIG. 4, the change in transmittance for 24 hours according to functionalization according to the type of stabilizer was 2.98% (functionalized stabilizer) and 6.43% (PVP, 55 k).

The SEM image is a scanning electron microscopy (SEM) photograph of the surface shape of the boron nitride nanotube dispersion of Liquid Crystal Example 1 and Liquid Crystal Example 2 cast on a silicon wafer, and the diameter distribution of the boron nitride nanotubes measured through the SEM photograph is shown schematically.

As a result of photo analysis, the Example with the smallest change in transmittance for 24 hours shows that it is dispersed at the level of a single tube, and it shows that the functionalized stabilizer is very effective in implementing the boron nitride nanotube liquid crystal phase.

Therefore, it was confirmed that the de-bundling efficiency was increased, and the boron nitride nanotube agglomeration of the high-concentration dispersion was prevented, thereby improving the long-term dispersion stability.

### Liquid Crystal Evaluation 3—Boron Nitride Nanotube Liquid Crystal Evaluation

Liquid crystal properties of boron nitride nanotubes were confirmed using dispersions prepared according to Liquid Crystal Example 1, Liquid Crystal Example 2, and Liquid Crystal Comparative Example 2. The concentration was gradually increased using a rotary concentration evaporator, and the liquid crystallinity was evaluated through a polarizer image according to the concentration.

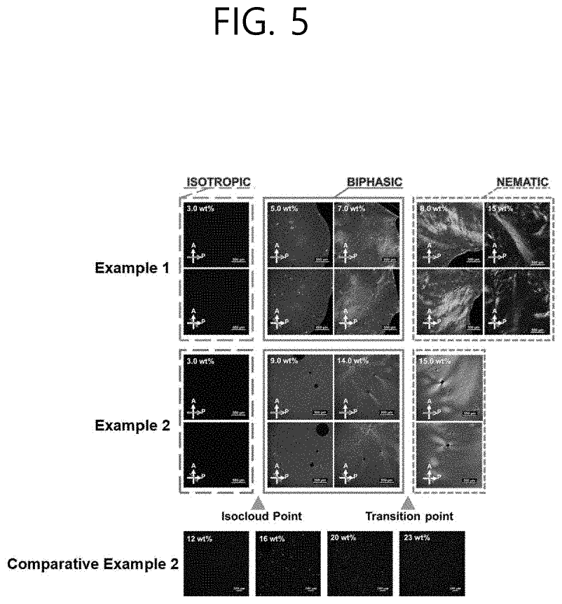

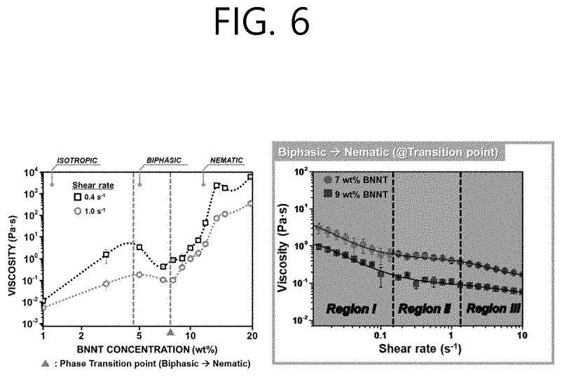

FIG. 5 and FIG. 6 show the polarizer image and viscosity according to the boron nitride nanotube liquid crystal concentration according to the type of stabilizer, and the viscosity according to the shear rate of the lyotropic nematic liquid crystal phase.

As shown in FIG. 5, the phase transition concentration to the liquid crystal phase according to the type of stabilizer was 7% by weight in Liquid Crystal Example 1 (purified boron nitride nanotube, functionalized stabilizer), 14% by weight in Liquid Crystal Example 2 (purified boron nitride nanotube, PVP, 55 k), and 16% by weight in Liquid Crystal Comparative Example 2 (unpurified boron nitride nanotube, functionalized stabilizer), and boron nitride nanotubes agglomerated and the liquid crystal phase could not be observed.

That is, the liquid crystal phase at a lower concentration than Liquid Crystal Example 2 can be observed in liquid crystal Example 1, so that the de-bundling efficiency is improved, indicating an increase in the exclusion volume of the boron nitride nanotubes, and in the Liquid Crystal Comparative Example 2, it can be confirmed that the liquid crystal phase was not realized due to isotropic impurities that interfere with alignment.

According to the results, the better the dispersing quality, the lower the phase transition concentration and the narrower the range of the biphasic window. This shows that the boron nitride nanotube liquid crystal phase is implemented easily through the stabilizer of the present invention.

Liquid Crystal Comparative Example 2, which uses unpurified boron nitride nanotubes, contains many isotropic impurities, which interfere with the self-assembly of nanotubes as the concentration of boron nitride nanotubes increases, and it aggregates with impurities including nanotubes, and thus does not implement a liquid crystal phase.

In addition, as the liquid crystal domains rheologically slide between the lyotropic liquid crystals, the viscosity is lowered in a section. When it was confirmed with the results of viscosity according to the concentration with the functionalized stabilizer, the rheological characteristics of boron nitride nanotubes and other types of boron nitride nanotubes and lyotropic liquid crystals used in the dispersion can be confirmed through FIG. 6.

### Boron Nitride Nanotube Fiber Experiment

### Fiber Example 1—Preparation of First Boron Nitride Nanotube Fibers

The liquid crystal composition prepared in Liquid Crystal Example 1 was spun through a wet spinning process using 15 wt % based on boron nitride nanotubes to obtain a gel fiber composite.

First, the liquid crystal composition was put into a syringe and then passed through a spinning nozzle having an inner diameter of 300 μm and discharged into the coagulation bath. The coagulation bath was prepared with a mixed solvent of acetone and water. At this time, the extrusion rate was 0.3 ml/min, the tensile ratio was 1.1, and the extrusion was performed.

The spun gel fiber composite was a liquid crystal gel fiber state, water was used to increase the density of boron nitride nanotubes, and the spun gel fiber composite was washed with a mixed solvent of acetone and water. Thereafter, the water of the gel fiber composite was slowly evaporated at room temperature and dried so that the density and the surface of the fiber were uniformly to obtain a first boron nitride nanotube fiber (boron nitride nanotube fiber containing a stabilizer).

### Fiber Example 2—Preparation of First Boron Nitride Nanotube Fibers

Under the same conditions as in Fiber Example 1, the purified boron nitride nanotube liquid crystal prepared using the boron nitride nanotube dispersion prepared in Liquid Crystal Example 2 {Using polyvinylpyrrolidone (55K)} was spun through a wet spinning process.

### Fiber Example 3—Second Boron Nitride Nanotube Fiber Production

A second boron nitride nanotube fiber was prepared by heat-treating the boron nitride nanotube composite fiber (Fiber Example 1) obtained under the same conditions as in Fiber Example 1 at 400° C. for 2 hours to remove the stabilizer remaining in the fiber.

### Fiber Comparative Example 1—Manufacturing of Boron Nitride Nanotube Fibers

Under the same conditions as in Fiber Example 1, the unpurified boron nitride nanotube liquid crystal prepared using the boron nitride nanotube dispersion prepared in Liquid Crystal Comparative Example 2(Unpurified boron nitride nanotube, functionalized stabilizer) was spun through a wet spinning process.

However, when the boron nitride nanotube dispersion prepared in Liquid Crystal Comparative Example 2 was spun through the boron nitride nanotube paste wet spinning process, continuous spinning and winding were impossible due to aggregation of a number of impurities and boron nitride nanotubes, so only fibers of shorter than 1 cm were partially wound.

### Textile Evaluation 1

As shown in [Table 1] below, the tensile strength of the boron nitride nanotube fiber prepared according to Fiber Example 1 was measured.

In the case of Fiber Comparative Example 1 using unpurified boron nitride nanotubes, the boron nitride nanotube paste was wound with fibers of less than 1 cm. As a result, the mechanical strength of the boron nitride nanotube fiber of Comparative Example 1 was not evaluated actually.

TABLE 1
Confirmation of mechanical properties
of boron nitride nanotube fibers

| | Tensile | Elongation | | I_{VV}/ | |
|---|---|---|---|---|---|
| | strength | @ break | Modulus | I_{VH} | |
| Dispersing agent | (cN/tex) | (% strain) | (cN/tex) | ratio | Remark |
| Functionalized | 4.75 | 2.81 | 342 | 1.95 | |
| (Fiber Example1) | | | | | |
| PVP (55k) | 2.80 | 2.86 | 312.7 | 1.56 | |
| (Fiber Example2) | | | | | |
| Functionalized | 4.22 | 0.55 | 1515.44 | 2.12 | |
| (After | | | | | |
| clacination) | | | | | |
| (Fiber Example3) | | | | | |
| Functionalized | — | — | — | 0.94 | Mechanical |
| (Fiber | | | | | properties |
| Comparative | | | | | cannot be |
| Example1) | | | | | measured |

The fiber prepared using the functionalized stabilizer (Fiber Example 1) exhibited the highest tensile strength value, and the lower the phase transition concentration of the liquid crystal, the higher the tensile strength value. This shows that the arrangement of the boron nitride nanotube fibers in the axial direction is advantageous during fiber production due to the low phase transition concentration of the liquid crystal, which shows that the fiber has excellent mechanical properties due to the high linear density.

### Textile Evaluation 2

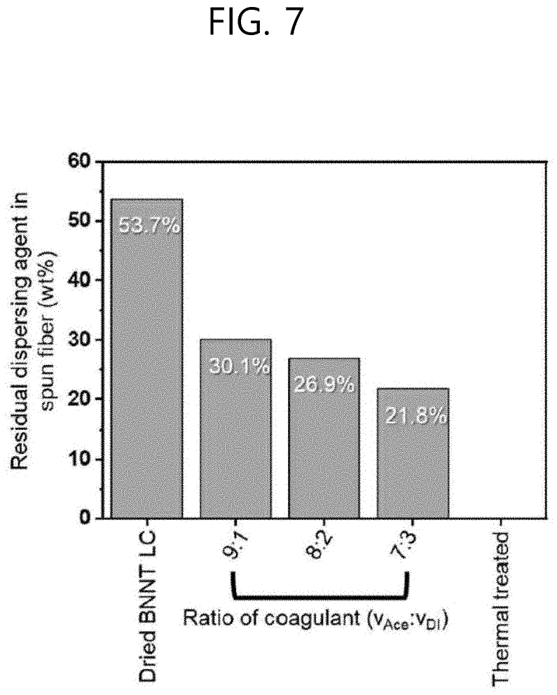

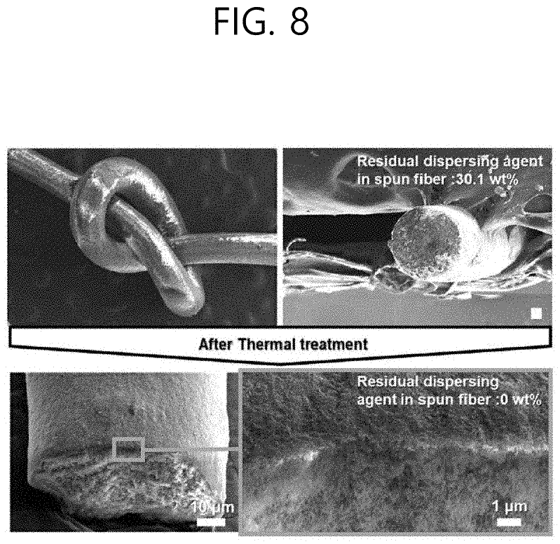

FIG. 7 and FIG. 8 show the cross-sectional SEM images of the boron nitride nanotube fibers before and after heat treatment and the results of checking the amount of the stabilizer in the boron nitride nanotube fibers by TGA.

As can be seen through FIG. 7 and FIG. 8, the amount of stabilizer remaining in the fiber and the cross-sectional SEM image result of the boron nitride nanotube fiber confirmed through the TGA results up to 800° C. at 10° C. per minute in an air atmosphere depending on whether heat treatment is performed is shown. (Fiber Example 1 vs Fiber Example 3)

As the fraction of water in the coagulation bath increases to 30% by volume, it decreases from 53% by weight to 21% by weight. In the case of the heat-treated fiber (Fiber Example 3), all the remaining stabilizer is removed and aligned in one direction to increase the linear density. A single boron nitride nanotube fiber with a high and smooth surface was obtained, and as shown in the SEM image of FIG. 8, it has a high linear density regardless of heat treatment.

### Fiber Evaluation 3—Boron Nitride Nanotube Fiber Evaluation

By checking the polarized images of the fibers prepared according to Fiber Example 1 and Fiber Comparative Example 1, it was confirmed whether and to what extent they were aligned in the axial direction.

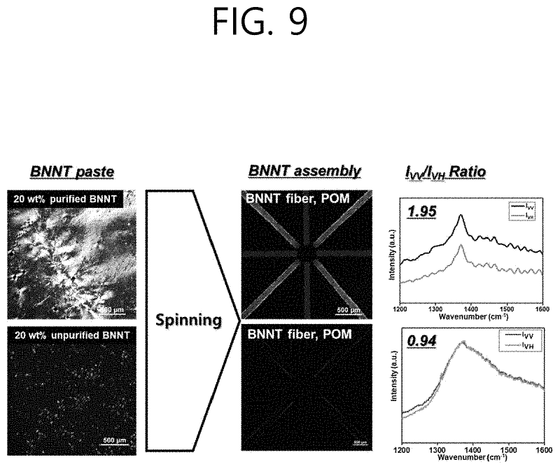

FIG. 9 is a view showing the birefringence and alignment of boron nitride nanotube fibers.

Polarized Raman was observed for Fiber Example 1 and Fiber Comparative Example 1.

As a result, in the polarized image, the polarizer of Example 1 of the fiber is positioned orthogonally, and it can be confirmed that the fiber is positioned at 45 degrees with respect to the polarizer and exhibits optical birefringence. This indicates that the fibers are aligned in the axial direction.

On the other hand, in Comparative Fiber Example 1, birefringence could not be confirmed at any angle, indicating that the boron nitride nanotube fibers were randomly arranged.

Fiber Example 1 had an alignment of 1.95 I_{VV}/I_{VH}, and Comparative Fiber Example 1 had an alignment of 0.94 I_{VV}/I_{VH}.

In the above, a preferred embodiment according to the present invention has been described with reference to the drawings and embodiments, but this is merely exemplary, those of ordinary skill in the art will understand that various modifications and other equivalent embodiments are possible therefrom. Accordingly, the protection scope of the present invention should be defined by the appended claims.

According to the present invention, a method for processing a boron nitride nanotube and a liquid crystal composition and a boron nitride nanotube fiber therefrom are provided.

What is claimed is:

1. A method for processing a boron nitride nanotube, the method comprising:
contacting the stabilizer with boron nitride nanotubes in a solvent; and
obtaining a liquid crystal composition comprising a liquid crystal in a state in which at least a part of the stabilizer is adsorbed on the surface of the boron nitride nanotubes by removing a portion of the solvent.

2. The method for processing a boron nitride nanotube according to claim 1, wherein the stabilizer is adsorbed to the surface of the boron nitride nanotubes through the secondary interactions,
disperses the boron nitride nanotubes through the repulsive force between the boron nitride nanotubes, and
comprises at least one of monomers, oligomers, polymers, and copolymers comprising at least one Lewis base capable of providing an electron pair to form a secondary bond.

3. The method for processing a boron nitride nanotube according to claim 2, wherein the stabilizer comprises monomers, oligomers, polymers, or copolymers thereof selected from the group consisting of Vinylpyrrolidone, Vinylalcohol, Acrylonitrile, Dopamine, and combinations thereof

4. The method for processing a boron nitride nanotube according to claim 1, wherein the stabilizer is selected from the group consisting of a Vinylpyrrolidone-vinylimidazole copolymer of [Formula 1] below, a Vinylpyrrolidone-vinylimidazolium copolymer of [Formula 2], and combinations thereof. 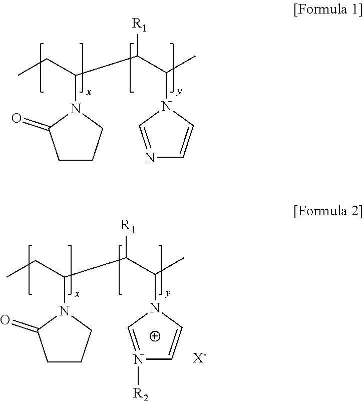
(In the above formula, R1 and R2 are the same or different, represent hydrogen or a hydrocarbon group having 1 to 16 carbon atoms, respectively, and optionally comprise one or more heteroatoms selected from oxygen, sulfur, nitrogen, phosphorus, fluorine, chlorine, bromine, iodine, and silicon. X⁻ in Chemical Room 2 is an anion of an imidazolium-based ionic liquid and may use a halogen anion component comprising Cl⁻ and Br⁻. In Formulas 1 and 2, x is 1 to 128, and y is 0 to 1.)

5. The method for processing a boron nitride nanotube according to claim 1, wherein the solvent comprises at least one of water, alcohol, dimethylformamide, dichloromethane, acetone, and amines,
the contacting is performed by supplying external energy to a mixed solution in which the solvent, the boron nitride nanotube and the stabilizer are mixed, and
the weight ratio of the boron nitride nanotubes and the stabilizer in the mixed solution is 1:0.01 to 1:10.

6. The method for processing a boron nitride nanotube according to claim 1, wherein the liquid crystal is lyotropic nematic phase, and
comprises 100 parts by weight of the boron nitride nanotube and 30 parts by weight to 300 parts by weight of the stabilizer.

7. The method for processing a boron nitride nanotube according to claim 6, wherein the method further comprises:
extruding the liquid crystal composition by contacting the liquid crystal composition with a coagulant;
gelling the extruded liquid crystal composition; and
obtaining a gel fiber composite by stretching and fiberizing the gelled liquid crystal composition.

8. The method for processing a boron nitride nanotube according to claim 7, wherein the method further comprises:
obtaining boron nitride nanotube fibers by densifying the gel fiber composite; and
wherein the densifying comprises:
obtaining a first boron nitride nanotube fiber through a first densifying to further remove the solvent in the gel fiber composite; and
obtaining a second boron nitride nanotube fiber through a second densifying to remove the stabilizer of the first boron nitride nanotube fiber.

9. The method for processing a boron nitride nanotube according to claim 8, wherein the impurity of the boron nitride nanotube is 1% by area to 30% by area.

10. A liquid crystal composition comprising a liquid crystal of boron nitride nanotubes, the liquid crystal composition comprising:
boron nitride nanotubes, a stabilizer, and a solvent,
wherein at least a portion of the stabilizer is adsorbed on the surface of the boron nitride nanotubes, and
the boron nitride nanotubes are in a liquid crystal state aligned in a predetermined direction in the solvent.

11. The liquid crystal according to claim 10, wherein the liquid crystal comprises:
100 parts by weight of the boron nitride nanotube and 30 parts by weight to 300 parts by weight of the stabilizer, wherein
20% to 80% by weight of the stabilizer is adsorbed to the boron nitride nanotube, and the remaining stabilizer is contained in the solvent,
the solvent comprises at least one of water, alcohol, diol, dimethylformamide, dichloromethane, acetone, and amines, and
the concentration of the boron nitride nanotubes in the liquid crystal composition is 0.05 wt % to 30 wt %.

12. The liquid crystal according to claim 10, wherein the liquid crystal comprises:
a first concentration section showing an isotropic state in which the viscosity increases as the concentration of the boron nitride nanotube increases in the solvent;
a second concentration section having a higher concentration than the first concentration section and decreasing the viscosity than the first concentration section to indicate a dual phase state; and
a third concentration section having a higher concentration than the second concentration section and increasing the viscosity than the second concentration section to indicate a lyotropic nematic phase state.

13. The liquid crystal according to claim 10,
wherein the liquid crystal is divided into a total of three regions with a viscosity according to the shear rate in the lyotropic nematic phase, and
the liquid crystal comprises:
a first region exhibiting shear thinning at a low shear rate, and in which the formed liquid crystal domains move in translation and the liquid crystal domains grow;
a second region having a constant viscosity section at an intermediate shear rate, and in which the alignment of the liquid crystal domains in the translation and shear directions competitively occurs; and
a third region exhibiting shear thinning again at a high shear rate, and in which the liquid crystal domains are predominantly aligned in the shear direction.

14. A boron nitride nanotube fiber comprises a boron nitride nanotube,
wherein a boron nitride nanotube fiber has optical birefringence, and
at least a portion of the boron nitride nanotube is arranged in a predetermined direction.

15. The boron nitride nanotube fiber according to claim 14,
wherein the boron nitride nanotube fibers comprise boron nitride nanotubes and a stabilizer,
at least a portion of the stabilizer is adsorbed on the surface of the boron nitride nanotube, and
a degree of alignment is 0.5 I_{VV}/I_{VH} to 5.5 I_{VV}/I_{VH}.

16. The boron nitride nanotube fiber according to claim 15,
wherein the boron nitride nanotube fibers comprise 20 parts by weight to 60 parts by weight of the stabilizer based on 100 parts by weight of the boron nitride nanotube, and
the boron nitride nanotube fiber has a tensile strength of 1 cN/tex to 8 cN/tex, an elongation at break of 1% to 5%, and a modulus of 200 cN/tex to 600 cN/tex.

17. The boron nitride nanotube fiber according to claim 15,
wherein the stabilizer is adsorbed to the surface of the boron nitride nanotubes through the secondary interactions,
the stabilizer help to disperse the boron nitride nanotubes through a repulsive force between the boron nitride nanotubes, and
the stabilizer comprises at least one of monomers, oligomers, polymers, and copolymers comprising at least one Lewis base capable of providing an electron pair to form a secondary bond.

18. The boron nitride nanotube fiber according to claim 14,
wherein the boron nitride nanotube fiber has at least a portion of the boron nitride nanotube in the boron nitride nanotube fiber aligned in the axial direction of the fiber, and
the boron nitride nanotube fiber has a degree of alignment of 1.5 I_{VV}/Iv_{VH} to 6.5 I_{VV}/I_{VH}.

19. The boron nitride nanotube fiber according to claim 18,
wherein the boron nitride nanotube fiber has a tensile strength of 1 cN/tex to 8 cN/tex, an elongation at break of 0.1% to 5%, and a modulus of 1000 cN/tex to 2000 cN/tex.

20. The boron nitride nanotube fiber according to claim 18,
wherein the boron nitride nanotube fiber has a tensile strength of 1.5 cN/tex to 8 cN/tex, an elongation at break of 0.3% to 3%, and a modulus of 1200 cN/tex to 2000 cN/tex.
